(19) United States
(12) Patent Application Publication
(10) Pub. No.: US 2009/0042013 A1
(43) Pub. Date: Feb. 12, 2009

(54) FILLER MATERIAL, ESPECIALLY FOR FILLING CAVITIES, ESPECIALLY OF STRUCTURAL ELEMENTS, METHOD OF PRODUCTION AND STRUCTURAL ELEMENT

(76) Inventors: Jurgen Finter, Zurich (CH); Norman Blank, Ruschlikon (CH)

Correspondence Address: BINGHAM MCCUTCHEN LLP, Three Embarcadero Center, San Francisco, CA, 94111-4067, US

(21) Appl. No.: 11/597,251

(22) PCT Filed: May 19, 2005
(86) PCT No.: PCT/EP2005/052303

§ 371 Date: Jul. 8, 2008

(30) Foreign Application Priority Data
May 19, 2004 (EP) 04102229.4

(51) Int. Cl. B32B 3/26; B32B 27/38

(52) U.S. Cl. 428/313.5; 428/407; 428/339

(57) ABSTRACT

The invention relates to a filler material, especially for filling cavities, especially of structural elements, to a method of production and to a structural element. The inventive filler material comprises particles that are coated with a reactive duroplast, whereby the reactive duroplast is non-viscous at room temperature when not yet reacted.

### THE TECHNICAL DOMAIN

The present invention relates to a filler material, especially for filling cavities, in particular of structural elements, whereby said filler material comprises particles that are coated with a reactive duroplastic. The present invention relates furthermore to a process for manufacturing a filler material, in particular a filler material as proposed whose particles are coated with a reactive duroplastic. The present invention relates furthermore to a structural element having a cavity.

### THE STATE OF THE ART

The production of both vehicles and containers requires that load-bearing metal components be at once light and exhibit considerable rigidity or solidity. This objective can, in many instances, be achieved if metal components are designed to have, for example, a sandwich construction wherein the cavities are filled with a porous material, for example, foam materials. Such sandwich structures are produced by bonding two metal covering layers to a foam core or by introducing foam between such layers, for example, with the aid of a PUR Reactive Resin System. Known in the art in addition to such synthetic material foams are the widely-known metallic foams that have the advantage of absorbing greater amounts of energy when undergoing deformation.

Also well known in the art is a method for obtaining reinforcing material for filling a cavity that involves pouring hollow spheres into a cavity which, after sealing, is filled with a low-viscosity agglutinant following which the interstices are filled with the agglutinant, which then hardens. The notable disadvantage of this method is that a cavity so prepared must be tightly sealed in order to prevent the egress of agglutinant.

Furthermore known in the art is a method in which particles of filler material contained in a fluid layer are coated by means of spraying with an epoxy resin system. The disadvantage attending this method is that the viscosity of such epoxy resin systems must be weak enough to allow application by means of spraying. At the same time, however, the epoxy resin system must be sufficiently reactive so as to permit it, in the environment in the fluid layer, to rapidly polymerize when heated.

Consequently, this objective calls for a solution which, following fluidization, involves the formation on the sphere surface of a partially cross-linked coat that exhibits both good adhesive properties and good mechanical load resistance. It would, however, be more expensive to render such coating more susceptible to sintering and more reactive at higher temperatures.

### SUMMARY OF THE OBJECTIVES OF THE PRESENT INVENTION

The object of the present invention is, therefore. the preparation of a filler material, a method for producing such filler material and a structural element that obviates the drawbacks of the state of the art.

It is proposed that the aforementioned objective be satisfied in-a filler material, more particularly for filling cavities especially in structural elements, whereby such filler material comprises particles that are coated with a reactive duroplastic which, in the unreacted state, does not flow at ambient temperature. The aforementioned objective will furthermore be satisfied by means of a method for the production of a particularly novel filler material comprising particles that are coated with a reactive duroplastic.

It is proposed firstly that the filler material be introduced into cavities in the structural element without requiring expensive structural modifications while obviating the egress of filler material, and secondly that the duroplastic system, for example an epoxy resin system, need not be weakly viscous and relatively highly reactive at the same time.

Further advantageous embodiments of the present invention will be described in the subsidiary claims.

### OVERVIEW OF THE DRAWINGS

The present invention will next be described in greater detail with the aid of drawings. The same elements appearing in different drawings are referenced with the same reference numerals.

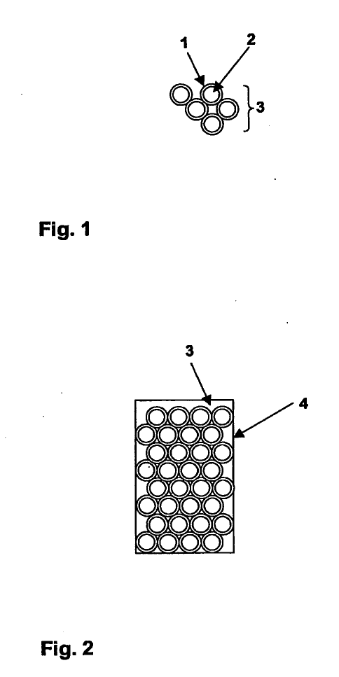

Shown in FIG. 1 is a plurality of filler material particles of the proposed filler material 3 whereby such filler material particles are formed from particles 2 that are, more particularly, hollow-bodied particles enveloped substantially uniformly with a duroplastic 1.

Shown in FIG. 2 is a structural element 4 featuring a cavity that is filled with a filler material 3.

In order to better convey the essence of the present invention, only the essential elements will be illustrated.

### THE EMBODIMENT OF THE PRESENT INVENTION

The present invention relates to compounds for duroplastics 1 or rather duroplastic materials 1 and in particular comprises epoxy resin formulations having a latent hardener, more particularly a thermal hardener which, preferably together with, for example, reactive fluid elastomers, form impact-resistant modified epoxy resin systems which, when in the unreacted state, do not flow at ambient temperature. In other words, at ambient temperature, such systems exhibit a sufficiently high viscosity typically in excess of 1,000 Pas, preferably in excess of 2,000 Pas and most preferably in excess of 3,000 Pas. Such formulations are applied at higher temperatures or at ambient temperature to the hollow spheres, i.e. to the particles 2, preferably by means of a centrifugal mixer. This novel method, astonishingly, permits the duroplastic 1 to homogenously or uniformly coat the particles or spheres. The viscosity level selected determines the desired degree of viscidity of the coated spheres. Should viscid coatings not be desired, said coatings can be dusted with a dry powder or be partially cross-linked by means of the addition of a second non-latent hardener immediately prior to coating.

The particles are preferably hollow, are preferably embodied as hollow spheres and most preferably are substantially uniformly coated. Since the insides of the particles are hollow, it is possible to produce an especially lightweight filler material. This confers considerable stability on the structural elements without adding an inappropriate amount of weight thereto. If the particles are embodied as spheres, especially as hollow spheres, their surface which is to be coated, is comparatively small and their ability to withstand impinging forces comparatively great.

It is furthermore proposed that the duroplastic exhibit unlimited storage stability at ambient temperature and be impact-resistant modified.

This arrangement permits the duroplastic material to be stored for extended periods of time, which in turn permits the filler material, due to relatively low logistical costs, to be produced in a cost-effective manner. It is consequently proposed that no or very little cross-linkage of the duroplastic material occur while the particles are being coated with duroplastic. Most of the cross-linkage of the duroplastic can take place during the full curing effected inside the structural element into which the particles to be coated have been poured. Such curing process when implemented, for example, in the automobile industry involves either pouring the coated particles into the cavity prior to cathode immersion painting and subsequent curing inside the baking kiln or, alternatively, pouring into the cavity and curing inside the baking kiln following cathode immersion painting. This method affords the further advantage of conferring increased stability on the duroplastic material and therefore also on the “filled” structural element.

Especially suitable as duroplastic systems are impact-resistant modified single-component epoxy-resin systems, which, when not crossed-linked at ambient temperature, exhibit a sufficiently high viscosity level typically in excess of 1,000 PAS, preferably in excess of 2,000 PAS and most preferably in excess of 3,000 PAS. Such epoxy-resin systems comprise typically mixtures of so-called solid resins or addition compounds (i.e. diphenols or dicarbonic acids to diglycidyl ethers which are solid at ambient temperature, and pre-elongated diglycidyl ethers of diphenols) with fluid diglycide ethers, impact-resistance enhancers such as thermoplastics, e.g. poly-p-phenylene oxide, polyalkylene oxide glycidyl ether, glycide ethers or reactive liquid rubbers and filler materials. Typical molecular weights for the solid resins or addition compounds lie between 800 and 10,000 Dalton, preferably between 900 and 8,000 Dalton. Employed preferably as hardeners are latent hardeners such as dicyandiamide or other substituted urea compounds that enable cross-linking starting at 160° C. In order to achieve partial cross-linking of the coat, it is also possible, in addition to latent hardeners, to add conventional epoxy hardeners such as polyphenols, mercaptans, amines, or anhydrous carbonic acids to the agglutinant systems immediately prior to coating. It is also possible, immediately prior to the coating procedure, to add diisocyanate to the agglutinant system and thus achieve pre-cross-linking via the β hydroxy groups of the epoxy addition compounds. Supplementary pre-cross-linking leads to higher molecular weights which, in turn, leads to a higher glass temperature and to a lowering of viscidity. Such systems are non-viscid when the glass temperature of the uncross-linked and pre-cross-linked viscid layer exceeds 30° C.

The coat is preferably selected to be as thin as possible, especially in light structure applications. The weight of the agglutinant as a proportion of that of the sphere lies between5% and 80%, preferably between 20% and 50% and most preferably 30%. The thickness of the coat lies between 2 and 200 μm, preferably between 5 and 100 μm, more preferably between 10 and 80 μm, and most preferably 50 μm.

It is furthermore contemplated by the invention that the coated particles will form filler material particles that feature either a viscid or a dry surface. The viscosity of the coated spheres or coated particles can be selected to provide a desired degree of viscidity, an arrangement, which, owing to adhesion to the inner walls, is of particular advantage where cavities of structural elements are to be filled. It is, however, also contemplated by the present invention that the coated particles not be viscid when used in other applications. In such applications, it is proposed that it be possible to sprinkle the coat with a dry powder which is employed to render the coat non-viscid or non-adherent.

It is furthermore proposed that the filler material particles be dusted with a powder, which is in particular. a thermoplastic powder and/or a latent hardener of the duroplastic and/or an inert filler. Use of thermoplastic powder such as poly(vinyl butyral) powder and/or polyamide powder, advantageously facilitates impact resistance. In addition to the thermoplastic powders, it is possible to use pulverized minerals or fillers such as, for example, calcium carbonate, wollastonite, quartz powder or pyrogenic silicic acid. Such powder can also feature, alone or in combination with other substances, a micronized, solid and latent hardener, such as, for example, dicyanamide. In this configuration of the present invention, it is advantageous to add part of the hardener as part of the duroplastic formulation and to add the rest of the hardener by sprinkling it in powder form. It is furthermore proposed that the powder employed for dusting alone or in combination with one or more other substances be an organic or a mineral filler.

In accordance with the present invention, it is preferable that the particles be coated with the duroplastic inside a centrifugal mixer. In such centrifugal mixer, an arm rotates at high speed in one direction in concert with a basket which, being attached to such arm, rotates in the opposite direction (hence the expression “Dual Asymmetrical Centrifuge”) so as to permit the material inside the machine to be thoroughly and rapidly mixed together, even when the viscosity of the duroplastic material, for example, is relatively high, and in particular exceeds a value at which spraying of the material would otherwise be enabled. The viscosity level can be modified by adjusting the temperature, to which end the agglutinant system is warmed until a viscosity of between 20 and 50 Pas is reached.

Four embodiment examples will be described in greater detail hereunder:

### EXAMPLE 1

### Coated Spheres, Viscid Surfaces, Resin System (SikaPower ®9496/3).

In this case, hollow steel spheres 3.2 mm in diameter, were used at a packed density of 0.36 g/ml. Employed as the duroplastic 1 for the coating material was a commercially-available structural agglutinant (SikaPower ®0496/3). Assuming homogenous coating of the spheres, it was anticipated that the coat enveloping the spheres would have the following thicknesses:

| | Calculated layer thickness |
|---|---|
| Percent by weight agglutinant | of the coat/agglutinant layer in μm |
| 10 | 12 |
| 20 | 30 |
| 30 | 50 |

Both spheres and agglutinant (total mass 70 g) were transferred into a beaker and heated to 80° C. Coating took place inside a Speedmixer DAC 150 FV (centrifugal mixer manufactured by Hauschild). This yielded homogenously-coated, slightly viscid, readily transportable spheres. The slightly viscid spheres were then poured into a cylindrical mould that had been treated with a separating agent (substituting for a cavity inside a structural element) and allowed to cure for 30 min. at 180° C. A rigid cylinder was hereby obtained.

Individual cured spheres were then cut open and the thicknesses of the layers measured at 200×magnification. The coat proved to be homogenous and corresponded to the calculated layer thicknesses.

### EXAMPLE 2

### Coated Spheres, Dry Surfaces, Impact-Resistant Modified Epoxy Resin System, Dusted with Butvar

Duroplastic or agglutinant and process method as in Example 1. The example involving 30% by weight agglutinant (70 g total weight) was repeated. Immediately following coating, the spheres were dusted with 5 g polyvinylbutyral Movital 60 HH. This yielded pourable spheres, which were then transferred into a cylindrical mould, whereby after curing for 30 min. at 180° C., a rigid cylinder was obtained.

### EXAMPLE 3

### Coated Spheres, Impact-Modified Epoxy Resin System

A reactive impact-modified epoxy-resin agglutinant was prepared by mixing 100 g of an addition compound comprising bisphenol-A-diglycide ether with dimeric fatty acid (Epoxy Value=2.8 epoxy equivalents/kg) together with 100 g solid epoxy resin (GT 7004, manufactured by Vantico AG, Epoxy Value=1.4 epoxy equivalents/kg) and 50 g of a fluid epoxy resin (GY 250 manufactured by Vantico) at 90° C. inside a planetary mixer.

Added to the homogenous mixture were 125 g of a reactive polyol (a polyol comprising epoxide groups) 130 g light filler (Extendospheres serving to lower the density of the duroplastic) and 6.5 g pyrogenic silicic acid (Cabosil TS 720, manufactured by Cabot) as well as 12.3 g dicyandiamide.

The reactive polyol comprising epoxy groups was prepared as follows: 200 g PolyTHF 2000 (PTMEG polytetramethylene ether glycol having a molecular weight of 2000 g/mol OH number 57.5 mg/g KOH) were dessicated inside a vacuum at 100° C. Next, 47.5 g IPDI (isophonone diisocyanate) and 0.04 g dibutylstannous laurate were added. The materials were reacted together in a vacuum at 90° C. for 2.5 hours until a constant nco level of 3.6% was attained (In theory, the nco level should be 3.7%.). Added next were 123.7 g trimethylol propane glycide ether (with 50% monohydroxyl-containing epoxide). The mixture was again stirred in a vacuum at 90° C. until, after another 3 hours, the nco level had fallen to below 0.1%.

The agglutinant, used in the manufacture of T-Peel and shear tension test bodies, was cured at 180° C. for 30 min. The following mechanical values were obtained:

| | |
|---|---|
| Tensile strength (MPa) | 22.4 |
| Elongation (%) | 4.75 |
| E-Modulus (MPa) | 1396 |
| T-Peel (N/mm) | 5.05) |

Obtained following addition of the aforementioned duroplastic to the particles or spheres, were filler material particles which, in the uncured state, exhibit a weakly-viscid surface. This was accomplished by mixing hollow bodies or particles, in particular hollow steel spheres, as described in Examples 1 and 2, with the duroplastic inside the centrifugal mixer, whereby such particles became coated with the duroplastic.

### EXAMPLE 4

### Coated Spheres, Dry Surfaces, Impact-Modified Epoxy-Resin System, Dusted with an Inert Filler

The duroplastic, or, rather the agglutinant described in example 3, was prepared using 6.1 g dicyandiamide. 49 g steel spheres or rather hollow steel spheres and 21 g agglutinant were transformed inside a Speedmixer into coated spheres. Next, the spheres, i.e. the filler material particles, were dusted with 250 mg dicyandiamide in g pyrogenic silicic acid. This method yielded dry coated spheres.

### List of Reference Captions

1. Duroplastic
2. Particles
3. Filler material
4. Structural element

1. Filler material (3), especially for filling cavities especially in structural elements, whereby filler material (3) comprises particles (2) which are at least partially coated with a reactive duroplastic (1), characterized in that reactive duroplastic (1) does not flow in the unreacted state at ambient temperature.

2. Filler material (2) in accordance with claim 1, characterized in that the reactive agglutinant in the unreacted state at ambient temperature features a viscosity exceeding 1,000 Pas, preferably in excess of 2,000 Pas and more preferably in excess of 3,000 Pas.

3. Filler material (3) in accordance with claim 1, characterized in that the thickness of the coat on particles (2) lies between 2 and 200 μm, preferably between 5 and 100 μm, more preferably between 10 and 80 μm and most preferably at 50 μm.

4. Filler material (3) in accordance with claim 1, characterized in that particles (2) are hollow and are preferably embodied as hollow spheres.

5. Filler material (3) in accordance with claim 1, characterized in that particles (2) are substantially uniformly coated.

6. Filler material (3) in accordance with claim 1, characterized in that duroplastic (1) is an epoxy resin system.

7. Filler material (3) in accordance with claim 1, characterized in that duroplastic (1) possesses substantially unlimited storage stability at ambient temperature and is in particular impact-resistant modified.

8. Filler material (3) in accordance with claim 1, characterized in that the coated particles form filler material particles that feature a viscid or a dry surface.

9. Filler material (3) in accordance with claim 1, characterized in that the glass temperature of the non-cross-linked and pre-cross-linked duroplastic exceeds 30° C.

10. Filler material (3) in accordance with claim 1, characterized in that the coated filler material particles are dusted with a powder which is in particular thermoplastic powder and/or a latent hardener of the duroplastic and/or an inert filler.

11. Process for preparing a filler material (3), in particular in accordance with claim 1, whereby particles (2) are coated with a reactive duroplastic (1), characterized in that coating of the particles (2) with duroplastic (1) is effected inside a centrifugal mixer.

12. Method for preparing a filler material (3), in particular in accordance with claim 1, whereby particles (2) are coated with a reactive duroplastic (1), characterized in that the temperature of reactive duroplastic (1) during the mixing process is such that the viscosity of the duroplastic lies between 20 and 50 Pas.

13. Structural element (4) having a cavity that is filled at least partially with a filler material (3) in accordance claim 1, whereby filler material (3) in particular is cured.
